(19) United States
(12) Patent Application Publication
(10) Pub. No.: US 2015/0212957 A1
(43) Pub. Date: Jul. 30, 2015

(54) Supply Assembly Of Imaging Device, Chip Thereon, And Method For Updating Slave Address

(71) Applicant: Apex Microelectronics Co., Ltd., Xiangzhou District (CN)

(72) Inventors: Yanqing Yuan, Xiangzhou District (CN); Linlin Zhang, Xiangzhou District (CN)

(21) Appl. No.: 14/299,443

(22) Filed: Jun. 9, 2014

(30) Foreign Application Priority Data
Jan. 29, 2014 (CN) CN 201410043789.9

(51) Int. Cl. G06F 13/362; G06F 3/12

(52) U.S. Cl. CPC G06F 13/362; G06F 3/1293

(57) ABSTRACT

The present disclosure discloses a supply assembly of an imaging device, a chip thereof, and a method for updating a slave address of the supply assembly. The method comprises: receiving, by the supply assembly, an address change instruction from the imaging device, the address change instruction including the slave address of the supply assembly; and gathering, by the supply assembly, upon first monitoring an addressing instruction after detection of the address change instruction, a second slave address contained in the addressing instruction first monitored, updating the slave address of the supply assembly into the second slave address, and sending acknowledging data to the imaging device. The supply assembly and its chip according to the present disclosure can rapidly respond to the instructions from the imaging device so as to perform the address change, and manufacturing costs thereof are also reduced.

### FIELD OF THE INVENTION

The present disclosure relates to a technical field of imaging and image developing, in particular to a supply assembly of an imaging device, a chip thereon, and a method for updating a slave address of the supply assembly.

### BACKGROUND OF THE INVENTION

As an imaging technique develops, imaging devices such as xerox, printers, fax machines, word processors, etc. are widely used. An imaging device is commonly provided with a conveniently removable supply assembly (such as an ink cartridge, a toner cartridge, etc.) for accommodating imaging materials (such as ink, toner, etc.). Especially for an imaging device having a color imaging function, four, five, six, eight, or even more supply assemblies are usually provided for respectively accommodating imaging materials of different colors or types. To facilitate recognition and operation of these supply assemblies by the imaging device, each of the supply assemblies is provided with a respective chip. The chips communicate with the imaging device via a common bus. That is to say, each chip has its own slave address, and the imaging device sends an address and instruction to the chip via the bus. The chip which has a slave address matching the address from the imaging device will respond to the instruction.

While communicating with a chip, the existing imaging device will send an instruction, requesting the chip which is connected to the bus to modify its slave address. After execution of the instruction, it is unnecessary for the chip to inform the imaging device of the modified address, since the imaging device will calculate the new slave address after modification, and call the chip by sending the new slave address. With respect to this type of imaging device, the chip usually needs to be provided with an address generator and same address change rules as those of the imaging device. Upon receipt of an address change instruction, the chip will control the address generator to generate a new slave address. Afterwards, the imaging device will inform the chip to respond by using the new slave address.

The method of arranging the address generator and the address change program in the chip for responding to the imaging device not only increases costs of the chip, but also extends time it takes the chip to respond to the imaging device after receiving the address change instruction since the address generator has to first operate the address change program to generate the new slave address, which is disadvantageous for rapid response of the chip. As a result, a chip which is of low costs, capable of rapid response, and high synchrony in address change with the imaging device, and a method for changing the slave address thereof are urgently required.

### SUMMARY OF THE INVENTION

According to the present disclosure, one technical problem to be solved is to provide a supply assembly chip of an imaging device that is of lower costs and meanwhile can secure rapid response to address change instructions from the imaging device.

To solve the above technical problem, the present disclosure provides a method for updating a slave address of a supply assembly of an imaging device. The method comprises the following steps: receiving, by the supply assembly, an address change instruction from the imaging device, the address change instruction including the slave address of the supply assembly; and gathering, by the supply assembly, upon first monitoring an addressing instruction after detection of the address change instruction, a second slave address contained in the addressing instruction first monitored, updating the slave address of the supply assembly into the second slave address, and sending acknowledge data to the imaging device.

Besides, the step of updating the slave address of the supply assembly into the second slave address upon first monitoring an addressing instruction after the detection of the address change instruction further comprises a sub-step of address change, in which a supply assembly chip judges whether the slave address thereof matches the slave address contained in the address change instruction upon receiving the address change instruction from the imaging device via a bus; and the supply assembly chip alters its chip mode from a mode of address holding into a mode of address to be changed without updating the slave address thereof, if yes, or maintains its chip mode as a mode of address holding, if no.

Also, the step of updating the slave address of the supply assembly into the second slave address upon first monitoring an addressing instruction after the detection of the address change instruction further comprises a sub-step of addressing response, in which the supply assembly chip judges whether it is in the mode of address to be changed upon receiving the addressing instruction from the imaging device; and the supply assembly chip updates the slave address thereof into the second slave address contained in the received addressing instruction, if yes, and sends acknowledge data to the imaging device via the bus.

In addition, the sub-step of addressing response further comprises: if no, the supply assembly chip further judging whether the slave address contained in the received addressing instruction matches the slave address of the chip, and sending acknowledge data to the imaging device via the bus only when matching.

Further, the step of updating the slave address of the supply assembly into the second slave address upon first monitoring an addressing instruction after the detection of the address change instruction further comprises altering its chip mode from a mode of address to be changed to a mode of address holding.

According to another aspect of the present disclosure, a supply assembly chip of an imaging device is further provided, comprising: an interface unit for communicating with the imaging device, a control unit for receiving a change instruction and/or addressing instruction from the imaging device via the interface unit, and an address recording unit for storing a slave address of the supply assembly chip. Upon first monitoring an addressing instruction via the interface unit after detection of an address change instruction that matches the slave address in the address recording unit, the control unit gathers a second slave address contained in the addressing instruction, updates the slave address stored in the address recording unit into the second slave address, and sends acknowledge data to the imaging device via the interface unit.

Still further, the control unit is further used for: judging whether the slave address in the address recording unit matches the slave address contained in the address change instruction upon receiving the address change instruction from the imaging device via the interface unit, and altering the mode of the supply assembly chip from a mode of address holding to a mode of address to be changed without changing the slave address thereof, if yes.

Furthermore, the control unit is further used for: judging whether the supply assembly chip represents the mode of address to be changed upon receiving the addressing instruction from the imaging device via the interface unit, storing the second slave address contained in the received addressing instruction into the address recording unit, if yes, and sending acknowledge data to the imaging device via the interface unit.

Moreover, the control unit is further used for: if no, further judging whether the slave address contained in the received addressing instruction matches the slave address recorded in the address recording unit, and sending acknowledge data to the imaging device via a bus only when matching.

Additionally, the modes of the supply assembly chip are represented in the following manners: representing a mode of address to be changed and a mode of address holding by different binary data stored, respectively; representing a mode of address to be changed and a mode of address holding by turn-on and turn-off of a switching circuit which connects the control unit to the address recording unit, respectively; and representing a mode of address to be changed by a read-write state of the address recording unit, and a mode of address holding by a read-only state of the address recording unit.

According to still another aspect of the present disclosure, it provides a supply assembly of the chip according the aforementioned technical solution, wherein the supply assembly is detachably arranged on an imaging device.

Compared with the prior art, the supply assembly and its chip according to the present disclosure can rapidly respond to the instructions from the imaging device so as to perform the address change. Meanwhile, the manufacturing costs thereof are also lowered.

Other advantages, purposes, and features of the present disclosure will be explained in some ways in the following description. In addition, to some extent, studies based on the following description would be obvious for one skilled in the art, or one skilled in the art would learn through practice of the present disclosure. The purposes and other advantages of the present disclosure will be achievable or obtainable through the structures as indicated in the following description, claims, and drawings.

### BRIEF DESCRIPTION OF THE DRAWINGS

The drawings are provided for further understanding of the present disclosure and constitute one part of the description. They serve to explain the present disclosure in conjunction with the embodiments, rather than to limit the present disclosure in any manner. In the drawings:

FIG. 1 schematically shows a structure of an imaging device according to the embodiments of the present disclosure;

FIG. 2 schematically shows a structure of a supply assembly chip according to the embodiments of the present disclosure;

FIG. 3 schematically shows data structure of an address change instruction;

FIG. 4 is a flowchart for requesting a chip to change its slave address by an imaging device according to the prior art;

FIG. 5 is a structural schematic diagram of a chip according to the present disclosure;

FIG. 6 is a flowchart for updating the slave address of the supply assembly chip according to the embodiments of the present disclosure;

FIG. 7 is a flowchart of general processes for judging whether it is a first time for the chip to detect an addressing instruction on a bus according to an embodiment of the present disclosure;

FIG. 8 is a structural schematic diagram of the chip according to another embodiment of the present disclosure; and

FIG. 9 is a flowchart of general processes for updating the address of the chip according to an embodiment of the present disclosure.

### DETAILED DESCRIPTION OF THE EMBODIMENTS

The present disclosure will be described in detail in conjunction with the accompanying drawings and embodiments, whereby the process of solving technical problems with respective technical means, and achieving the technical effects can be sufficiently understood and implemented. It should be noted that, as long as there are no conflicts, the embodiments and the technical features disclosed in each and every embodiment of the present disclosure can be combined with one another in any way. And the technical solutions formed thereby all fall within the scope of the present disclosure.

Furthermore, the steps as illustrated in the flowcharts of the drawings can, for example, be executed in a computer system with a set of computer executable instructions stored thereon. In addition, although logical sequences are shown in the flowcharts, under some circumstances, the steps as shown or depicted can be executed in different orders.

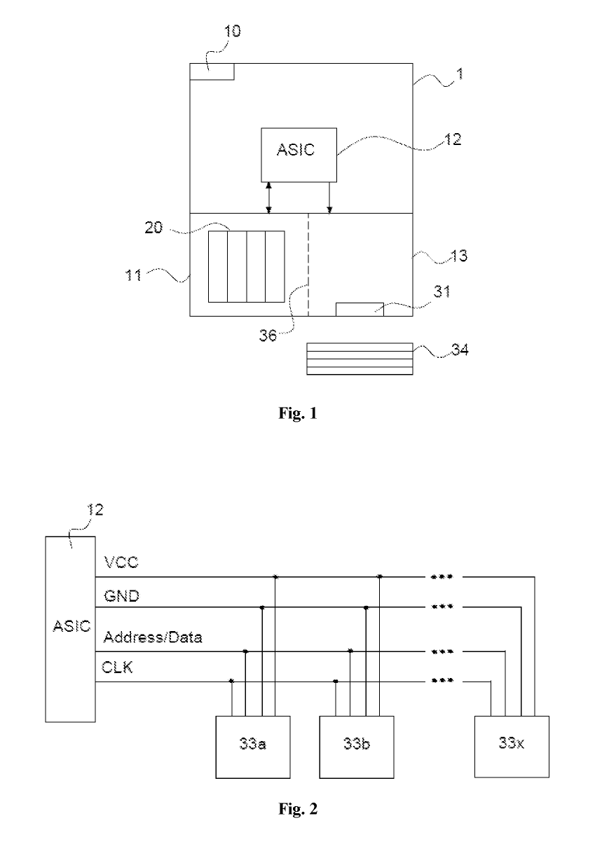

FIG. 1 is a schematic diagram of an imaging device 1 used in the present disclosure. The imaging device 1 comprises a user interface 10, an installation position 11 for a supply assembly, an application-specific integrated circuit (ASIC) 12, and an image recording unit 13. The user interface 10 is used for connecting peripherals such as computers, cell phones, video cameras, etc., so as to facilitate receipt of user instructions from the peripherals by the imaging device. The installation position 11 for the supply assembly can be detachably arranged with a plurality of supply assemblies 20 which accommodate different colors or types of imaging materials to be supplied to the image recording unit 13. The imaging device 1 can, for example, be an inkjet printer and/or copier, or an electrophotographic printer and/or copier.

In the example of the imaging device 1 as listed above, the image recording unit 13, which can for example be an inkjet print head unit or an electrophotographic printing unit, comprises an imager head 31 used for forming images on a substrate 34 of, for example, a print media or a photosensitive element. For the sake of convenience, each type of substrate 34 is indicated by a number 34, for example, a print media 34. The supply assembly 20 can, for example, be an ink container, an inkjet printhead cartridge (PH), a toner container, or an electrophotographic processing cartridge (EP), each of which includes storage of imaging materials such as ink or toner for consumption during imaging processes. The imaging device 1 forms images on the print media 34 by using the imaging materials contained in the supply assembly 20. The print media 34 can, for example, be scraps of paper, fabric sheets, or transparent film.

One ordinarily skilled in the art is supposed to know that the image recording unit 13 and the supply assembly 20 can be formed as separate, discrete units, or can be combined into an integral unit, with the supply assembly 20 being detachably mounted in the imaging device 1. For example, in an inkjet technique, the integral unit can be an ink reservoir and the inkjet printhead cartridge PH of the inkjet printhead formed as a single consumable. Therefore, for the sake of convenience, “the supply assembly” can be used in the above separate or integral configuration as an example of consumable. Preferably, an outer wall of the supply assembly 20 is provided with a chip for storing information relating to the supply assembly 20. The chip communicates with the imaging device via a bus. Where the inkjet printhead cartridge PH is used, the chip can be a part of the printhead silicon.

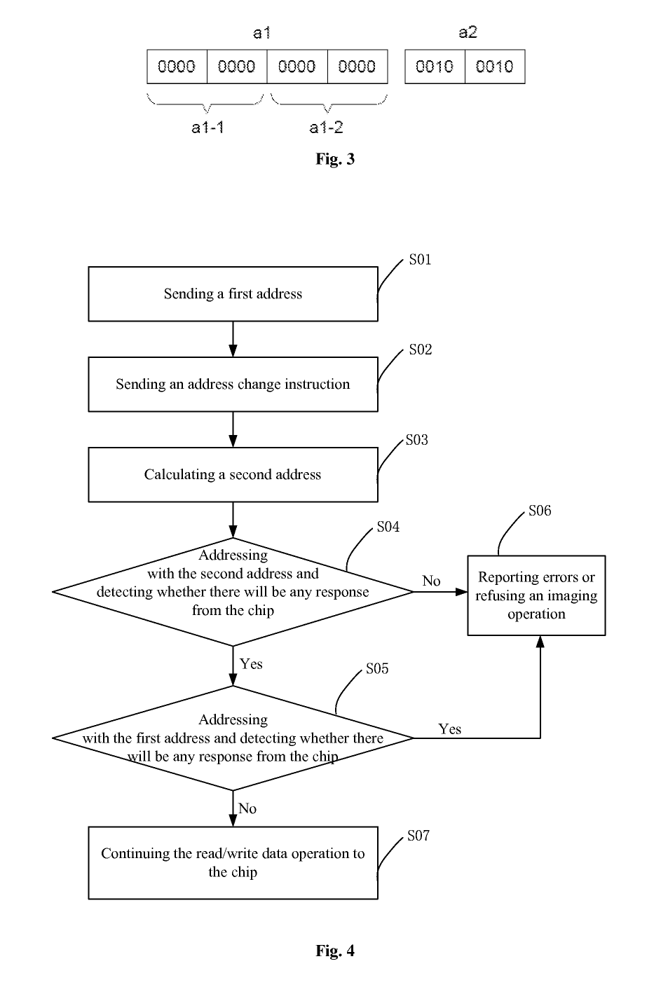

As shown in FIG. 2, an application-specific integrated circuit (ASIC) 12 of the imaging device 1 communicates with chips 33a, 33b . . . , 33x of the plurality of supply assemblies via the bus. The bus includes a power line VCC, a clock line CLK, and an address and/or data line Address/Data. The chips 33a, 33b . . . , 33x each are electrically connected to the aforementioned bus and receive a power supply and signals. When the imaging device 1 accesses a certain chip, the application-specific integrated circuit (ASIC) 12 sends an addressing instruction to the chips 33a, 33b . . . , 33x via the address data line Address/Data (i.e., transmits the slave address of the chip to be accessed). The chips 33a, 33b . . . , 33x compare the slave address received with their respective slave addresses, send acknowledge data (e.g., 0 or 1) to the bus when matching, and continue to receive and respond to other instructions on the bus; or do not respond to the acknowledge data on the bus when not matching. Generally, the chips on the bus each have an original slave address which is kept unchanged. However, a certain imaging device requests the chip to change its slave address during a communication process, in which case the original slave address of the chip will be restored after power down of the chip. FIG. 3 depicts an address change instruction sent to the bus by the imaging device. The instruction comprises an address portion al and a command portion a2, wherein the address portion al represents a present slave address of the chip which is required to execute the address change instruction from the imaging device on the bus. The address portion a1 includes an immutable address a1-1 and an alterable address a1-2, wherein the immutable address a1-1 represents data not to be changed in the slave address after execution of the address change instruction by the chip, while the alterable address a1-2 represents data to be changed after the execution of the address change instruction by the chip. In FIG. 3, the immutable address a1-1 comprises an 8-bit binary data, and the alterable address a1-2 comprises an 8-bit binary data. The number of bits of the immutable address a1-1 and the alterable address a1-2, however, are actually not restricted. The address portion al has at least one datum as the alterable address a1-2.

FIG. 4 shows a flowchart of requesting a chip to change its slave address by an imaging device according to the prior art. In the following, the steps of changing the slave address of a supply assembly chip according to the prior art will be illustrated in connection with FIG. 4.

In step S01, the imaging device sends to the chip an addressing instruction containing a present slave address (a first address for short) of the chip, and waits for acknowledge data sent by the chip via a bus. More specifically, in order to respond to this, the chip will compare its respective slave address with the first address received from the bus, and generate acknowledge data to be transmitted to the bus when matching.

In step S02, the imaging device, after receipt of the acknowledge data from the bus, sends an address change instruction which contains the first address to request the chip to change its slave address. The chip generates a new slave address (referred to as a second address) using its address generator, and updates its slave address into the second address.

In step S03, the imaging device calculates the new address (the second address for short) after the address change of the chip, wherein, the imaging device may calculate the second address by executing an algorithm routine pre-stored in its memory, or by querying a sequence table for change of the slave address previously stored in its memory, so as to deduce the new address of the chip.

In step SO4, the imaging device sends an addressing instruction that contains the second address to the bus, detects whether there is an acknowledge signal from the chip, and executes step S05 if yes, or executes step S07 if no.

In step S05, the imaging device sends an addressing instruction that contains the first address to the bus, detects whether there is an acknowledge data from the chip, and executes step S06 if yes, or executes step S07 if no.

In step S06, the imaging device reports errors or refuses an imaging operation.

In step S07, the imaging device continues the operation of reading or writing to the chip.

An existing chip suitable for the imaging device is provided with same address changing rules as those arranged in the imaging device. When the chip receives an address change instruction, it will control the address generator which generates a new slave address, so that when the imaging device sends the new slave address, the chip can make a response. However, the chip with an address generator is of complex structures and high costs. Furthermore, to the disadvantage of rapid response of the chip, it requires a series of calculations and procedures for the address generator to generate a new address.

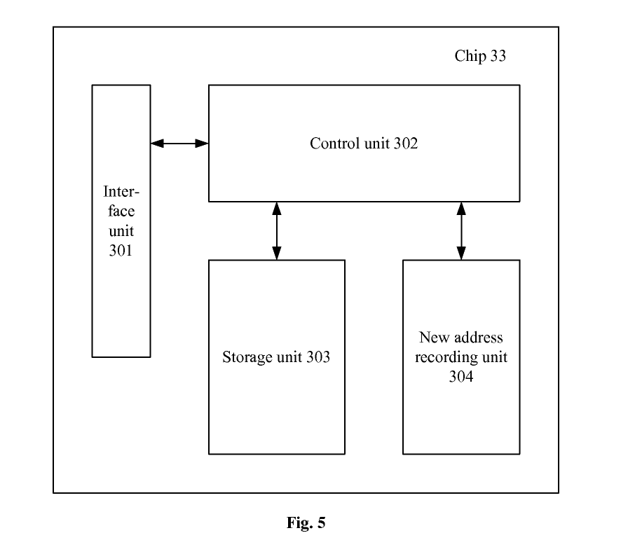

FIG. 5 schematically shows a chip 33 provided by the present disclosure. The chip 33 comprises an interface unit 301, a control unit 302 which receives a signal transmitted by the interface unit 301, a storage unit 303 electrically connected to the control unit 302, and a new address recording unit 304. The interface unit 301 is used for communicating with the imaging device 1, and can specifically be a contact terminal provided on a substrate surface of the chip 33, wherein when the supply assembly 20 is mounted on the supply assembly installation position 11 of the imaging device 1, the contact terminal of the chip 33 electrically contacts a side terminal of the imaging device, so as to connect to the imaging device 1 via the bus. Naturally, the interface unit 301 can also be an antenna provided on the substrate of the chip 33 for wirelessly communicating with the imaging device. The control unit 302 is electrically connected to the interface unit 301 for receiving an instruction from the bus and controlling the chip 33 which makes a response. More specifically, change instructions and/or addressing instructions from the imaging device 1 are received via the interface unit 301. The storage unit 303 and the new address recording unit 304 can also be generally called an address recording unit. The storage unit 303 saves the original slave address and the factory information of the chip 33 (hereinafter referred to as the original address), and other information relating to imaging operation history such as states of the supply assembly, etc. The new address recording unit 304 is used for storing at least one part of the new address that is gathered by the chip from the bus upon first detecting an addressing instruction from the bus after last receipt of an address change instruction from the imaging device. The new address recording unit 304 can specifically be a volatile or nonvolatile memory capable of storing data such as a register, latch, temporary memory, RAM, EEPROM, Flash, FeRAM, OUM, OPT, etc. for recording a new address from the bus. When the chip is powered on, the imaging device first addresses the chip with the original address of the chip. At this time, when receiving the addressing instruction from the imaging device, the chip determines whether to respond to the imaging device by judging whether the slave address contained in the addressing instruction matches the original address stored in the storage unit 303. When receiving an addressing instruction again after an address change operation, the chip will determine whether to respond to the imaging device by judging whether the slave address contained in the addressing instruction matches the slave address stored in the new address recording unit 304. The following is described by taking the chip 33a as an example.

Upon receipt of an address change instruction from the imaging device by the interface unit 301, the control unit 302 judges whether the slave address in the address recording unit matches the slave address contained in the address change instruction. If yes, the chip 33a is altered from a mode of address holding into a mode of address to be changed without updating its slave address. If no, the mode thereof (address holding) is kept unchanged.

Upon receipt of an addressing instruction from the imaging device 1 by the control unit 302 of the chip 33a via the interface unit 301, the chip 33a judges whether the mode thereof represents a mode of address to be changed. If yes, the chip 33a stores the second slave address contained in the received addressing instruction into the new address recording unit 304, and sends acknowledge data to the imaging device 1 via the interface unit 301. Under this circumstance, the chip 33a can alter the mode thereof from a mode of address to be changed back to a mode of address holding.

If the result of judgment is a mode of address holding, the control unit 302 of the chip 33a further judges whether the slave address contained in the received addressing instruction matches the slave address recorded in the address recording unit of the chip 33a. The chip 33a sends acknowledge data to the imaging device 1 via the bus only when matching.

As can be seen from the above, during the communications, the imaging device 1 will request the chip 33a to change its slave address. It should be noted that, when receiving an address change instruction from the imaging device 1, the chip 33a will not respond to the address change instruction to generate a new address and update its slave address. Instead, the chip 33a waits for the imaging device to send an addressing instruction to the bus. Upon first detecting an addressing instruction on the bus after last receipt of an address change instruction from the imaging device 1, the chip 33a gathers a new address on the bus, stores the new address into the new address recording unit 304, and sends acknowledge data to the bus. In this way, when the imaging device 1 sends an addressing instruction again, the chip 33a will determine whether to respond to the addressing instruction according to the new address that has been stored.

Here, the new address recording unit 304 can record a complete slave address of the chip, or only save an alterable portion of the slave address. When the imaging device addresses once again, the chip can judge whether the alterable address portion on the bus matches the alterable address stored in the new address recording unit 304, so as to determine whether to respond to the addressing from the imaging device. In addition, since the immutable portion in slave address of the chip is fixed, the chip 33a can generate a complete new address with the alterable portion stored in the address recording unit 304 and the immutable portion of the original address, and compare the new address with the address from the bus, so as to determine whether to respond to the addressing from the imaging device. For sake of conveniently describing, the slave address which may be completely recorded in the new address recording unit 304 is taken as an example. One ordinarily skilled in the art should understand that the following process steps are equally suitable when only the alterable portion of the slave address is stored in the new address recording unit 304.

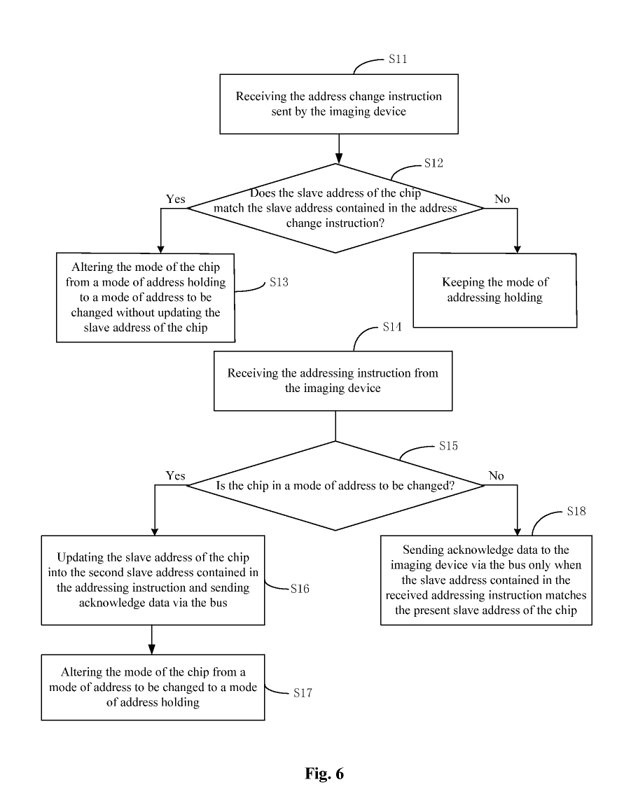

FIG. 6 is a flowchart showing the process steps for updating the slave address of the supply assembly chip according to the embodiments of the present disclosure. The chip 33a will be taken as an example of the supply assembly chip for explanation.

In step S11, a supply assembly chip 33a receives an address change instruction from an imaging device 1 via an interface unit 301, wherein the address change instruction comprises a slave address of the supply assembly chip 33a.

In step S12, a control unit 302 of the supply assembly chip 33a judges whether the slave address thereof matches the slave address contained in the address change instruction, and executes step S13, if yes, or keeps the mode of addressing holding, if no.

In step S13, the mode of the chip is altered from a mode of address holding to a mode of address to be changed with the slave address of the chip not being updated.

In step S14, the interface unit 301 of the supply assembly chip 33a receives an addressing instruction from the imaging device 1.

In step S15, the control unit 301 of the chip 33a judges whether the chip is in a mode of address to be changed, and executes Step S16, if yes, or executes Step S18, if no.

In step S16, the control unit 302 of the chip 33a gathers a second slave address contained in the addressing instruction, updates the slave address of the chip 33a into the second slave address, and sends acknowledge data to the imaging device via the bus. More specifically, updating of the slave address can be performed by storing the second slave address in the new address recording unit 304. In this case, step S17 is optionally executed.

In step S17, the control unit 302 of the chip 33a alters the mode of the chip 33a from a mode of address to be changed to a mode of address holding.

In step S18, the control unit 302 of the supply assembly chip further judges whether the slave address contained in the received addressing instruction matches the present slave address of the chip 33a, and sends acknowledge data to the imaging device via the bus only when matching.

To conclude above, in the method for updating the slave address of the supply assembly chip according to the embodiment as indicated in FIG. 6, upon first monitoring an addressing instruction after detection of an address change instruction from the imaging device 1, the control unit 302 of the supply assembly chip gathers the second slave address contained in the addressing instruction first monitored, updates the slave address thereof into the second slave address, and sends acknowledge data to the imaging device 1.

A plurality of manners can be used to represent modes of the chip 33a.

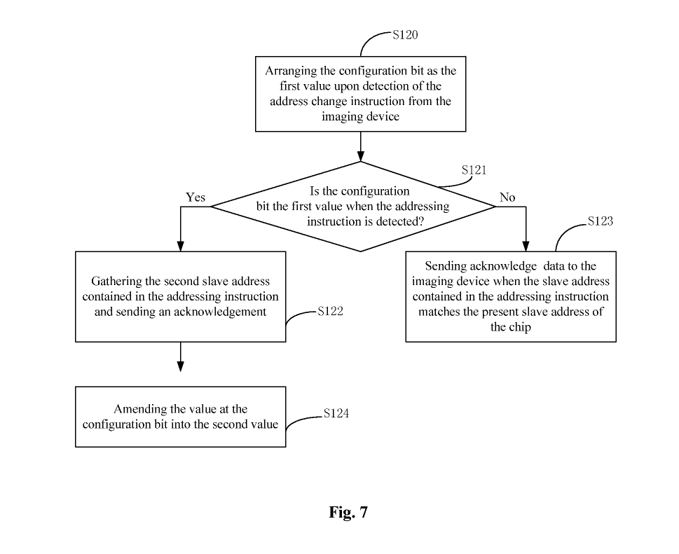

For example, a mode of address to be changed and a mode of address holding can be represented by different binary data stored, respectively by arranging a configuration bit in the chip 33a. Specifically, the configuration bit can be arranged as a first value or a second value, wherein the first and second values can be represented by two different binary data such as “0” and “1”, or, certainly can be indicated by two groups of multi-bit binary data also. The control unit 302 can judge whether it is a first time for the chip 33a to detect an addressing instruction from the bus after receiving an address change instruction by reading the values at the configuration bit. When the control unit 302 reads the first value at the configuration bit, it is determined that the addressing instruction from the bus is first detected after receipt of an address change instruction, whereas when the control unit 302 reads the second value at the configuration bit, it is determined that the addressing instruction from the bus is not first detected after receipt of an address change instruction. Specific sub-steps are shown in FIG. 7.

In sub-step S120, the configuration bit is arranged as the first value, by the control unit 302 of the chip 33a, upon detection of an address change instruction from the imaging device.

In sub-step S121, the control unit 302 reads the value at the configuration bit upon detection of an addressing instruction from the imaging device on the bus by the chip 33a, judges whether the value at the configuration bit is the first or second value, and executes Sub-step S122 when the first value is read, or executes Sub-step S123 when the second value is read.

In sub-step S122, the control unit 302 determines that it is the first detection of an addressing instruction from the bus after receipt of an address change instruction, gathers the second slave address contained in the addressing instruction and sends a response (corresponding to Step S16 as indicated in FIG. 6), and executes Sub-step S124.

In sub-step S123, if the control unit 302 determines that it is not the first detection of an addressing instruction from the bus after receipt of an address change instruction, it further judges whether the slave address contained in the received addressing instruction matches the present slave address of the chip 33a, and sends acknowledging data to the imaging device via the bus only when matching (corresponding to Step S18 in FIG. 6).

In sub-step S124, the value at the configuration bit is amended into the second value.

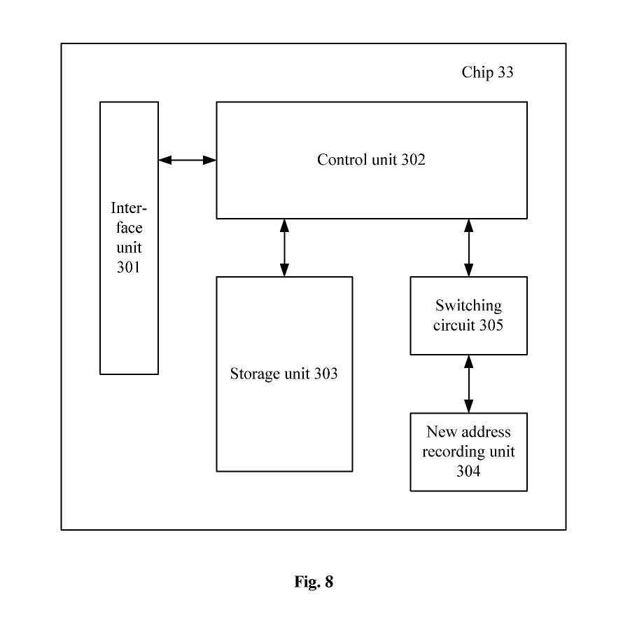

Fog another example, a mode of address to be changed and a mode of address holding can be represented by turn-on and turn-off of a switching circuit which connects the control unit to the address recording unit, respectively. As shown in FIG. 8, the chip 33a further comprises a switching circuit 305 which is electrically connected to the control unit 302 and the new address recording unit 304. When the chip 33a detects an address change instruction from the imaging device, the switching circuit 305 is turned on under the control of the control unit 302. When the chip 33a detects an addressing instruction on the bus for the first time, the control unit 302 can store the new address from the bus into the new address recording unit 304 via the turned-on switching circuit 305 which is then turned off. When the chip 33a detects an addressing instruction from the bus once again, the control unit 302 will not store the new address from the bus into the new address recording unit 304 since the switching circuit 305 is turned off. The switching circuit 305 will not be turned on until a next address change instruction is detected by the chip 33a.

For still another example, a mode of address to be changed can be represented by a read-write state of the address recording unit 304, and a mode of address holding by a read-only state of the address recording unit 304. When the chip 33a detects an address change instruction from the imaging device, the new address recording unit 304 is arranged as in the read-write state. When the chip 33a first detects an addressing instruction on the bus, the control unit 302 may write the new address from the bus into the new address recording unit 304, and then change the new address recording unit 304 into the read-only state. When the chip 33a detects another addressing instruction on the bus, the control unit 302 can only read the new address stored in the new address recording unit 304, which will not be changed back into the read-write state until the chip 33a detects still another address change instruction from the imaging device.

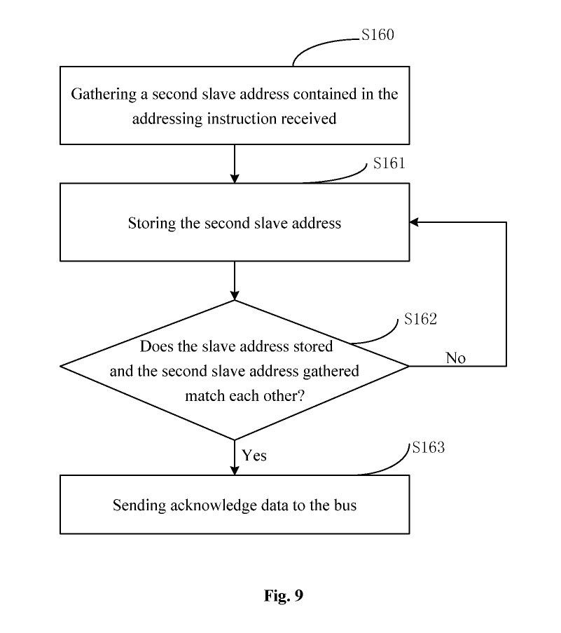

Step S16 of sending acknowledging data to the bus comprises the following specific sub-steps as indicated in FIG. 9.

In sub-step S160, the control unit 302 gathers a second slave address contained in the addressing instruction received via the bus.

In sub-step S161, the new address recording unit 304 stores the second slave address gathered by the control unit 302.

In sub-step S162, the control unit 302 judges through comparisons, whether the slave address stored in the new address recording unit 304 and the second slave address gathered from the bus match each other, and executes sub-step S163 if yes, or executes sub-step S161, if no.

In sub-step S163, acknowledging data are sent to the bus.

In the above sub-steps, the control unit 302 judges, through comparisons, whether the changed address stored in the new address recording unit 304 and the changed address gathered from the bus are consistent, and generates acknowledging data to be sent to the bus, which can effectively verify accuracy of the changed address stored in the new address recording unit 304 in Sub-step S161, so as to further ensure consistence between the new address of the chip and the address calculated by the imaging device. Of course, as errors seldom occur about the new address stored in the address recording unit 304, Sub-step S162 can be omitted in practice so as to accomplish rapid response of the chip. In order to further shorten response time of the chip, Sub-step S163 can also be performed between Sub-step S160 and Sub-step S161.

Furthermore, the control unit 302 can store the changed address into the new address recording unit 304, specifically by erasing the data originally stored in the new address recording unit 304 before writing the changed address into the new address recording unit 304, the storage mode of which does not require the new address recording unit 304 of large memory spaces, thus lowering cost and size of the chip. Of course, the control unit 302 can also write the changed address directly into the new address recording unit 304 without erasing the address originally stored therein, and marks the changed address as a present address for addressing of the imaging device, the storage mode of which saves time for erasing and writing addresses in the new address recording unit 304, thus facilitating rapid response of the chip.

Upon receipt of an address change instruction from the imaging device, instead of performing calculation to generate a new address, the chip provided by the present disclosure will directly send acknowledging data to a bus, gather and store a new address contained in an addressing instruction from the bus as an updated, new slave address of the chip. The chip is capable of responding to operations of the imaging device, thus effectively avoiding inconsistence between the address modified by the chip and the address calculated by the imaging device, which would otherwise lead to non-recognition of the imaging device by the chip. Furthermore, the arrangement of only one memory region to the chip for storing the new address will suffice, wherein the memory region can be separately arranged, or can be placed in the register of the control unit or in the storage unit of the chip. As such, the chip is of simple structures and low costs.

Although the embodiments disclosed by the present disclosure are discussed above, the embodiments are provided for better understanding of the present disclosure rather than to limit the present disclosure. The one skilled in the art can make amendments or modification to the implementing forms and details of the embodiments, without departing from the spirit or scope of the present disclosure. However, the scope of the present disclosure is only defined in the accompanying claims.

1. A method for updating a slave address of a supply assembly of an imaging device, comprising the following steps of:
receiving, by the supply assembly, an address change instruction from the imaging device, the address change instruction including the slave address of the supply assembly; and
gathering, by the supply assembly, upon first monitoring an addressing instruction after detection of the address change instruction, a second slave address contained in the addressing instruction first monitored, updating the slave address of the supply assembly into the second slave address, and sending acknowledging data to the imaging device.

2. The method according to claim 1, wherein the step of updating the slave address of the supply assembly into the second slave address upon first monitoring an addressing instruction after the detection of the address change instruction further comprises a sub-step of address change, in which
a supply assembly chip judges whether the slave address thereof matches the slave address contained in the address change instruction upon receiving the address change instruction from the imaging device via a bus; and
the supply assembly chip alters its chip mode from a mode of address holding into a mode of address to be changed without updating the slave address thereof, if yes, or maintains its chip mode as a mode of address holding, if no.

3. The method according to claim 2, wherein the step of updating the slave address of the supply assembly into the second slave address upon first monitoring an addressing instruction after the detection of the address change instruction further comprises a sub-step of addressing response, in which the supply assembly chip judges whether it is in the mode of address to be changed upon receiving the addressing instruction from the imaging device; and
the supply assembly chip updates the slave address thereof into the second slave address contained in the received addressing instruction, if yes, and sends acknowledging data to the imaging device via the bus.

4. The method according to claim 3, wherein the sub-step of addressing response further comprises:
if no, the supply assembly chip further judging whether the slave address contained in the received addressing instruction matches the slave address of the chip, and sending acknowledging data to the imaging device via the bus only when matching.

5. The method according to claim 1, wherein the step of updating the slave address of the supply assembly into the second slave address upon first monitoring an addressing instruction after the detection of the address change instruction further comprises altering its chip mode from a mode of address to be changed to a mode of address holding.

6. The method according to claim 2, wherein the step of updating the slave address of the supply assembly into the second slave address upon first monitoring an addressing instruction after the detection of the address change instruction further comprises altering its chip mode from a mode of address to be changed to a mode of address holding.

7. The method according to claim 3, wherein the step of updating the slave address of the supply assembly into the second slave address upon first monitoring an addressing instruction after the detection of the address change instruction further comprises altering its chip mode from a mode of address to be changed to a mode of address holding.

8. The method according to claim 4, wherein the step of updating the slave address of the supply assembly into the second slave address upon first monitoring an addressing instruction after the detection of the address change instruction further comprises altering its chip mode from a mode of address to be changed to a mode of address holding.

9. A supply assembly chip of an imaging device, comprising:
an interface unit for communicating with the imaging device,
a control unit for receiving an address change instruction and/or addressing instruction from the imaging device via the interface unit, and
an address recording unit for storing a slave address of the supply assembly chip,
wherein upon first monitoring an addressing instruction via the interface unit after detection of an address change instruction that matches the slave address in the address recording unit, the control unit gathers a second slave address contained in the addressing instruction, updates the slave address stored in the address recording unit into the second slave address, and sends acknowledging data to the imaging device via the interface unit.

10. The supply assembly chip according to claim 9, wherein the control unit is further used for:
judging whether the slave address in the address recording unit matches the slave address contained in the address change instruction upon receiving the address change instruction from the imaging device via the interface unit, and
altering the mode of the supply assembly chip from a mode of address holding to a mode of address to be changed without changing the slave address thereof, if yes.

11. The supply assembly chip according to claim 10, wherein the modes of the supply assembly chip are represented in the following manners:
representing a mode of address to be changed and a mode of address holding by different binary data stored, respectively;
representing a mode of address to be changed and a mode of address holding by turn-on and turn-off of a switching circuit which connects the control unit to the address recording unit, respectively; and
representing a mode of address to be changed by a read-write state of the address recording unit, and a mode of address holding by a read-only state of the address recording unit.

12. The supply assembly chip according to claim 10, wherein the control unit is further used for:
judging whether the supply assembly chip represents the mode of address to be changed upon receiving the addressing instruction from the imaging device via the interface unit,
storing the second slave address contained in the received addressing instruction into the address recording unit, if yes, and
sending acknowledging data to the imaging device via the interface unit.

13. The supply assembly chip according to claim 12, wherein the modes of the supply assembly chip are represented in the following manners:
representing a mode of address to be changed and a mode of address holding by different binary data stored, respectively;
representing a mode of address to be changed and a mode of address holding by turn-on and turn-off of a switching circuit which connects the control unit to the address recording unit, respectively; and
representing a mode of address to be changed by a read-write state of the address recording unit, and a mode of address holding by a read-only state of the address recording unit.

14. The supply assembly chip according to claim 12, wherein the control unit is further used for:
if no, further judging whether the slave address contained in the received addressing instruction matches the slave address recorded in the address recording unit, and
sending acknowledging data to the imaging device via a bus only when matching.

15. The supply assembly chip according to claim 14, wherein the modes of the supply assembly chip are represented in the following manners:
representing a mode of address to be changed and a mode of address holding by different binary data stored, respectively;
representing a mode of address to be changed and a mode of address holding by turn-on and turn-off of a switching circuit which connects the control unit to the address recording unit, respectively; and
representing a mode of address to be changed by a read-write state of the address recording unit, and a mode of address holding by a read-only state of the address recording unit.

16. A supply assembly, wherein the supply assembly is detachably arranged on an imaging device and comprises the supply assembly chip according claim 9.

17. The supply assembly according claim 16, wherein the control unit of the supply assembly chip is further used for:
judging whether the slave address in the address recording unit matches the slave address contained in the address change instruction upon receiving the address change instruction from the imaging device via the interface unit, and
altering the mode of the supply assembly chip from a mode of address holding to a mode of address to be changed without changing the slave address thereof, if yes.

18. The supply assembly according claim 17, wherein the control unit is further used for:
judging whether the supply assembly chip represents the mode of address to be changed upon receiving the addressing instruction from the imaging device via the interface unit,
storing the second slave address contained in the received addressing instruction into the address recording unit, if yes, and
sending acknowledging data to the imaging device via the interface unit.

19. The supply assembly according claim 18, wherein the control unit is further used for:
if no, further judging whether the slave address contained in the received addressing instruction matches the slave address recorded in the address recording unit, and
sending acknowledging data to the imaging device via a bus only when matching.

20. The supply assembly according claim 17, wherein, the modes of the supply assembly chip are represented in the following manners:
representing a mode of address to be changed and a mode of address holding by different binary data stored, respectively;
representing a mode of address to be changed and a mode of address holding by turn-on and turn-off of a switching circuit which connects the control unit to the address recording unit, respectively; and
representing a mode of address to be changed by a read-write state of the address recording unit, and a mode of address holding by a read-only state of the address recording unit.

21. The supply assembly according claim 20, wherein, wherein the control unit is further used for:
judging whether the supply assembly chip represents the mode of address to be changed upon receiving the addressing instruction from the imaging device via the interface unit,
storing the second slave address contained in the received addressing instruction into the address recording unit, if yes, and
sending acknowledging data to the imaging device via the interface unit.

22. The supply assembly according claim 21, wherein the control unit is further used for:
if no, further judging whether the slave address contained in the received addressing instruction matches the slave address recorded in the address recording unit, and
sending acknowledging data to the imaging device via a bus only when matching.
